(19) United States
(12) Patent Application Publication
(10) Pub. No.: US 2025/0095012 A1
(43) Pub. Date: Mar. 20, 2025

(54) SYSTEM FOR SIMULATING A CONTENT DELIVERY PLATFORM

(71) Applicant: Uber Technologies, Inc., San Francisco, CA (US)

(72) Inventors: Yue Yin, San Francisco, CA (US); Ludovica Rizzo, San Francisco, CA (US); Solomon Barkley, San Francisco, CA (US); Guillaume De Roo, San Francisco, CA (US)

(21) Appl. No.: 18/650,785

(22) Filed: Apr. 30, 2024

Related U.S. Application Data
(60) Provisional application No. 63/583,082, filed on Sep. 15, 2023.

(51) Int. Cl. G06Q 30/0204; G06Q 30/08

(52) U.S. Cl. CPC G06Q 30/0205; G06Q 30/08

(57) ABSTRACT

A simulation system accesses historical data generated from a real-world execution of a content delivery platform for a particular market that is defined at least in part by a prior time interval. A set of simulation configurations are identified for the simulation execution, where each simulation configuration represents a deviation to the real-world execution of the content delivery platform. A simulation execution of the content delivery platform for the particular market is generated using the set of simulation configurations. The outcomes of the simulation execution are then recorded and analyzed.

### RELATED APPLICATIONS

This application claims benefit of priority to provisional U.S. Patent Application No. 63/583,082, filed Sep. 15, 2023; the aforementioned priority application being hereby incorporated by reference.

### TECHNOLOGY FIELD

This disclosure relates to content delivery platforms, and more specifically, to a system for simulating a content delivery platform.

### BACKGROUND

Ad delivery platforms exist for various services and networks. Traditionally, such platforms target content items to users based on contextual information determined about a user. Typically, adjustments to improve the performance and efficacy of the ad delivery platform is learned over-time, through the performance of the ad delivery platform. In some approaches, experimentation is used, where an adjustment is made to the ad delivery platform, and the results are then analyzed. In this regard, processes for tuning and optimizing ad delivery platforms have been limited, sometimes requiring adjustments that impact the operations of the ad delivery platform.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 illustrates an example content delivery platform for use with one or more embodiments.

FIG. 2 illustrates a content delivery simulation system, according to one or more embodiments.

FIG. 3 illustrates an example method for simulating execution of a content delivery platform for a particular market, according to one or more embodiments.

FIG. 4A illustrates an example method for performing a simulation execution of a content delivery platform, where the simulation execution is configured by a bidding logic configuration, according to one or more embodiments.

FIG. 4B illustrates an example method for performing a simulation execution of a content delivery platform, where the simulation execution is configured by an auction process configuration, according to one or more embodiments.

FIG. 5 is a block diagram that illustrates a computer system on which examples described herein may be implemented.

### DETAILED DESCRIPTION

Examples provide for a computer system, method and non-transitory computer readable medium to generate a simulation of a content delivery system for a defined market. In examples, a simulation system accesses historical data generated from a real-world execution of a content delivery platform for a particular market that is defined at least in part by a prior time interval. A set of simulation configurations are identified for the simulation execution, where each simulation configuration represents a deviation to the real-world execution of the content delivery platform. A simulation execution of the content delivery platform for the particular market is generated using the set of simulation configurations. The outcomes of the simulation execution are then recorded and analyzed.

Among other advantages, a simulation system as described provides an efficient and cost-effective mechanism to determine how the performance of a content delivery platform can be improved or optimized. Under conventional approaches, experimentation requires adjustment to mechanisms of a content delivery platform in the real-world domain. These adjustments can only be analyzed in the time frame of the real-word domain (e.g., days), and at considerable expense, in that active campaigns are affected.

In contrast to experimentation and other conventional approaches, examples, provide for a system to effectively simulate the performance of a content delivery platform, allowing for variations to the content delivery platform to be investigated quickly (e.g., minutes or hours) without affecting actual campaigns that are in progress.

As used herein, a user device can correspond to a mobile computing device (e.g., cellular device or smartphone), a desktop computer, a laptop computer, tablet, wearable or other computing device operated by a user. device.

One or more examples described provide that methods, techniques, and actions performed by a computing device are performed programmatically, or as a computer-implemented method. Programmatically, as used, means through the use of code or computer-executable instructions. These instructions can be stored in one or more memory resources of the computing device. A programmatically performed step may or may not be automatic.

One or more examples described can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs, or machines.

Some examples described can generally require the use of computing devices, including processing and memory resources. For example, one or more examples described may be implemented, in whole or in part, on computing devices such as servers, desktop computers, cellular or smartphones, and tablet devices. Memory, processing, and network resources may all be used in connection with the establishment, use, or performance of any example described herein (including with the performance of any method or with the implementation of any system).

Furthermore, one or more examples described may be implemented through the use of instructions that are executable by one or more processors. These instructions may be carried on a computer-readable medium. Machines shown or described with figures below provide examples of processing resources and computer-readable mediums on which instructions for implementing examples described can be carried and/or executed. In particular, the numerous machines shown with examples described include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

In the following description, for the purpose of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

It will be further understood that: the term “or” may be inclusive or exclusive unless expressly stated otherwise; the term “set” may comprise zero, one, or two or more elements; the terms “first”, “second”, “certain”, and “particular” are used as naming conventions to distinguish elements from each other does not imply an ordering, timing, or any other characteristic of the referenced items unless otherwise specified; the term “and/or” as used herein refers to and encompasses any and all possible combinations of one or more of the associated listed items; that the terms “comprises” and/or “comprising” specify the presence of stated features, but do not preclude the presence or addition of one or more other features.

### System Overview

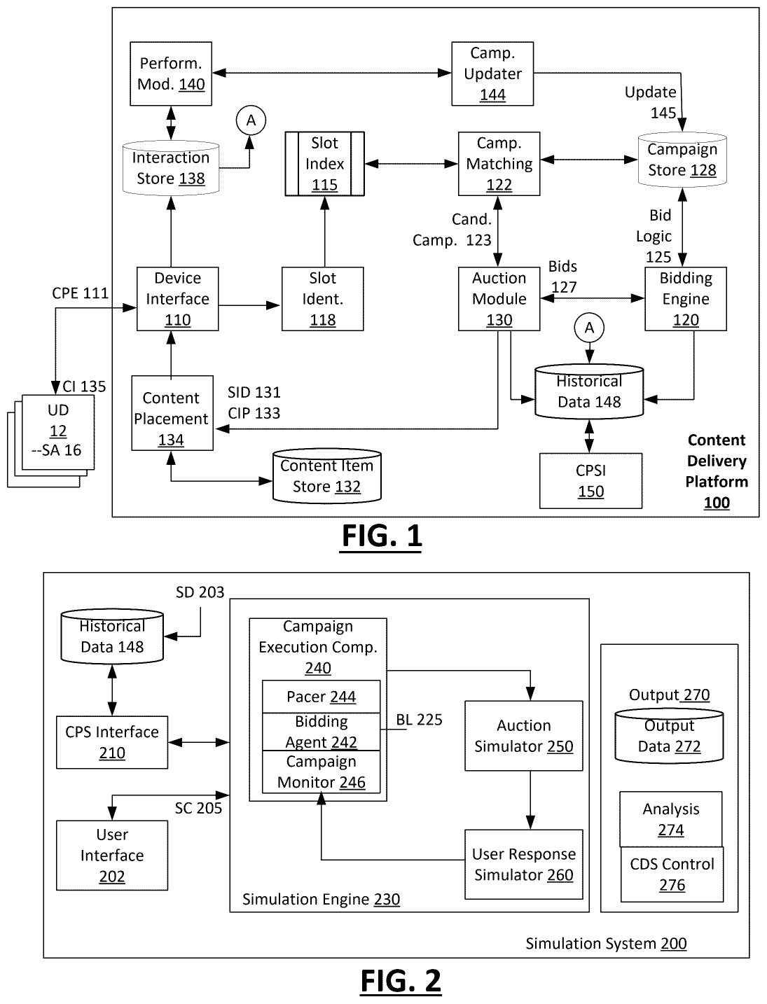

FIG. 1 illustrates an example content delivery platform for use with one or more embodiments. In examples, a content delivery platform 100 can be implemented on a network computing system to target content items to a plurality of user devices. The content items can include advertisements and promotional content, provided through advertisement campaigns of third-parties (e.g., advertisers). In some examples, the content delivery platform 100 can be implemented to deliver content items to user devices in conjunction with the user devices receiving or otherwise utilizing a particular service. For example, the content delivery platform 100 can deliver content items to user devices that execute a service application for a particular type of service, such as a food delivery service (e.g., for prepared foods at restaurants), a package delivery service, a grocery delivery service, a user transport service, or other type of delivery are transport service. In such examples, the content items that are delivered by the content delivery platform 100 can be rendered through the respective service applications that the user's operate on the respective user devices 12 to receive services.

Further, in examples, the content delivery platform 100 can target content items to user devices 12 based on a variety of factors, including contextual parameters such as a geographic location of the user and/or an activity of the user. For example, content items can be targeted to users based on their location, as well as an activity (e.g., search for a particular type of cuisine on a food delivery service application) they perform using the service application. In such examples, the targeted content items can correspond to advertisements or promotions that are deemed relevant to the user activity and location. For example, a user may view online menus of nearby restaurants, before performing a search of a particular type of cuisine (e.g., “Thai”). The content delivery platform 100 can select content items based on the user's location (e.g., a promotion for a nearby restaurant), the user's current interest (e.g., an advertisement for a type of wine the user may enjoy), and/or a specific user activity (e.g., a promotional banner identifying a Thai restaurant that matches the user search criteria).

In examples, the content delivery platform 100 includes processes represented by a device interface 110, a bidding engine 120, an auction module 130, a performance module 140, and a content platform simulation interface (“CPSI”) 150. The content delivery platform 100 can also maintain or access a campaign store 128, where information for active campaigns is maintained. The device interface 110 includes processes that communicate, over one or more networks, with a plurality of user devices (e.g., represented by user device 12). In some examples, the device interface 110 includes processes that communicate with the user device 12 and its service application 16 upon the user opening the service application 16. The device interface 110 can also associate the user device 12 with an account and profile. Still further, the device interface 110 can establish a communication link through which application content can be communicated to the user device 12.

In examples, the device interface 110 can also include processes that detect the occurrence of content placement events 111 on the user device 12. The content placement events 111 can correspond to, for example, a user opening the service application 16, the user interacting with the service application 16, and/or the user performing a particular type of interaction (e.g., navigate a menu, perform a search).

Further, in examples, each content placement event 111 can represent an opportunity, or a set of opportunities, for the placement of content items, such as advertisements, promotions or banners. For example, the service application 16 can be configured to render application content with one or more slots, where each slot defines a screen location where a content item from the content delivery platform 100 is to be rendered. The slots associated with, for example, a particular page or screen can include, for example, a prominent slot (e.g., appearing top of page), a banner slot, intermediate slots and bottom slots (e.g., appearing on bottom of screen). Further, a user session can be associated with one or multiple slots.

In examples, each content placement event 111 is associated with a set of contextual parameters can be determined from the user device 12 from which the content placement event 111 was generated (e.g., location). Still further, the contextual parameters can be determined from the service application 16, reflecting, for example, a state of the service application (e.g., just opened, user performing a search) and/or a particular activity the user performs. Additionally, processes can be implemented to infer contextual parameters and information that may be relevant to the content placement event 111. For example, contextual parameters can be determined from a profile of the user. The device interface 110 can associate the content placement event with an account identifier, and a profile associated with the account identifier can be used to identify a preference of a user. In this way, the content placement event 111 can be associated with a preference of a user of the associated device 12.

A slot identification component 118 represents processes that identify each slot associated with a content placement event 111. In some examples, multiple slots can be associated with a content placement event 111. For example, a content placement event 111 can correspond to the service application 16 being opened on a user device 12, resulting in an application page that has multiple available slots (e.g., a top slot, a banner slot, multiple intermediate slots, etc.). The slot identification component 118 can generate a list or index of available slots 115, where each entry of the index 115 is associated with contextual information determined from the device or account associated with the corresponding content placement event.

In examples, a campaign matching component 122 can identify a set of candidate campaigns 123 for each available slot. Each active campaign of the campaign store 128 can be associated with, for example, keywords or parameters that identify a desired target for the campaign. The campaign matching component 122 can identify a set of candidate campaigns for each auction based on a relevance between the associated contextual information of the slot and the parametric information for the targets of each active campaign. The campaign matching component 122 matches the parametric information for each campaign with contextual information associated with available slots of the slot index 115. In this way, each slot is associated with a set of candidate campaigns.

The auction module 130 initiates an auction process to determine content items for available slots. For each auction, the bidding engine 120 uses bidding logic 125 associated with the profile of each candidate campaign to generate bids 127 on behalf of the campaign. The bidding logic 125 can include parametric information that identifies, for example, one or more of (i) a bidding strategy, (ii) a pacing methodology, and (iii) one or more budget constraints, which can reflect the bid values (e.g., maximum bid, minimum bid, starting bid) that are to be generated for the campaign. The pacing methodology can determine whether a bid is to be submitted for a particular auction, as well as the maximum bid amount. Factors which may be considered by the pacing methodology when making its determinations include a number of winning bids for the campaign prior to a current instance, an overall budget for the campaign, a remaining budget for the campaign, a duration of time remaining for the campaign and/or other parameters. The bidding engine 120 can access the campaign profile of each candidate campaign from the campaign store 128.

In examples, the auction module 130 can also implement processes to determine eligibility of candidate campaigns, based on contextual or relevance determinations. For example, the auction module 130 can determine eligibility of a campaign for a particular auction based on a system-wide objective (e.g., distribute auction wins to all advertisers).

The auction module 130 performs an auction process for each available slot, based on bids 127 submitted by the bidding engine 120. The auction module 130 processes the bids on a variety of factors to determine winning bids and prices. These factors can include scoring and/or ranking bids 127 based on determined metrics such as quality and/or relevance of the content item associated with the bid. Additionally, the auction module 130 can evaluate the bids based on a price associated with each bid.

The auction module 130 identifies the slot identifier 131 and campaign identifier 133 for the winning campaign of the winning auction to a content placement component 134. The content placement component 134 uses the campaign identifier to identify, from a content item store 132, a reference link, content identifier, or content item associated with that campaign identifier. The content placement component 134 then delivers data, via the device interface 110, data for retrieving and/or rendering the corresponding content item 135 on the respective user device.

In examples, the device interface 110 also includes processes for detecting user interactions of different types with content items 135 delivered to respective user devices 12. The types of interactions can include the users receiving and/or viewing delivered content items 135 on their respective devices 12, the users interacting with the delivered content items 135 (e.g., user clicks on ad), and/or the users conducting a transaction through or in response to a delivered content item 135. The device interface 110 can record instances of the detected interactions with an interaction store 138. The interaction store 138 can include data that identifies a content item (e.g., by campaign), an available slot, contextual parameters of the available slot, and an interaction detected with respect to the content item 135, including a type of interaction. In some examples, the device interface 110 detects different types of interactions by individual devices 12, and records instances of the interactions with an interaction store 138. The device interface 110 can also record instances when no interaction is detected to a delivered content item 135.

In examples, the performance module 140 includes processes that monitor for and evaluate a performance of campaign, specifically by determining an effectiveness of a content items 135 to cause a desired response amongst users who receive the content item. Thus, the performance module 140 can determine performance by determining the effectiveness of a content item or campaign based on interactions the content items receives from users of devices. The performance module 140 can evaluate the effectiveness of campaigns based on the detected user interactions and the cost (e.g., bid value) for placing content items for the campaign. Thus, for example, the performance module 140 can determine a return-on-investment (ROI) for a particular campaign, given the cost of placing bids for the campaign, and the interaction or user response detected from the delivered content items.

Further, the performance module 140 can include processes for updating campaigns based on the determinations of the effectiveness of a content item or campaign. For example, a campaign update component 144 can represent various processes for determining an update 145 to individual campaigns while the campaigns are ongoing. The updates 145 can include, for example, tuning bidding logic 125 and other aspects of campaigns based on the performance of the campaign. For example, the bidding logic 125, including the pacing methodology or budget limit of a campaign, can be updated based on the performance of the campaign. Additionally, the target recipients of a campaign can be updated to reflect the determined effectiveness of the campaign's content item in terms of specific contextual information reflecting an attribute of a recipient (e.g., geographic location).

Still further, the performance module 140 can include processes to monitor ongoing aspects of campaigns, and to make adjustments to campaigns while they are in progress. For example, the performance module 140 can monitor the spending of individual campaigns (e.g., number of auction processes which campaign participated in and won over a duration of the campaign). The performance module 140 can monitor to ensure, for example, that the campaign is spending according to a predetermined spending plan and/or in accordance with the pacing methodology. By way of illustration, the performance module 140 can prevent a campaign from spending all of its budget in a single day, when the campaign is to continue for several days.

In examples, the content delivery platform 100 can also include processes to maintain historical data (e.g., logs) of events. In an example shown, a historical data store 148 can record historical data of a prior time interval, recording events that occur in the course of the auction processes. For example, the historical data store 148 can record auction data, representing (i) a set of candidate campaigns that are matched or deemed eligible for each available slot, (ii) the bids that are received for the auctioning of each available slot, (iii) the methodology used to select each winning bid of an auction process, and/or (iv) the identification of the winning bid, campaign and/or associated content item.

The historical data store 148 can also include bidding data, where the bidding data can include identification of bidding logic 125 used by each campaign that was active for the particular market. The historical bidding data can indicate, for example, at least one of a bidding strategy, a bidding pace methodology, and/or a bidding price constraint for each active campaign.

Further, the historical data store 148 can also include slot data that identifies each available slot at a particular time or time interval. The slot data can be based on, for example, the available slot index 115 of the content delivery platform 100. The slot data can also record each user session, where one or multiple slots are associated with each user session.

Still further, the historical data store 148 can the user interaction generated by individual content items delivered through the content delivery platform 100. For example, the historical data store 148 can record whether individual content items received no interaction, were viewed, were selected (e.g., clicked) or generated a transaction.

In this way, the content delivery platform 100 can include archival processes that continuously record historical data resulting from execution of the content delivery platform. Further, the historical data store 148 can reflect very recent data, such as data that was recorded a fraction of a second, seconds, minutes or hours prior to a current time. In this way, the historical data store 148 can record historical data of the content delivery platform 100 spanning a time interval that extends hours, days, weeks or longer, up to a recent moment in time (e.g., a fraction of a second, seconds, minutes or hours before a current time).

As described in greater detail, the CPSI 150 represents processes that make the historical data store 148 available to a system that can simulate the execution of the content delivery platform 100. For example, the CPSI 150 can make the historical data store 148 available in real-time (e.g., as it is being built through execution of the content delivery platform 100) to a system that simulates the execution of the content delivery platform 100 during a prior time interval. Still further, the historical data store 148 can be carried, via the CP SI 150, for data sets that represent historical data pertaining to the execution of the content delivery platform 100 for a particular market, such as a market that is defined by geography and are a time interval.

FIG. 2 illustrates a content delivery simulation system, according to one or more embodiments. A content delivery simulation system 200 (“simulation system 200”) can be implemented in conjunction with a content delivery platform 100 such as described with an example of FIG. 1. For example, the simulation system 200 can be integrated with the content delivery platform 100. Alternatively, the simulation system 200 can be implemented independently of the content delivery platform 100.

According to examples, the simulation system 200 operates to simulate execution of the content delivery platform 100 for a defined market. As described with examples, the simulation system 200 can be configured by one or more simulation parameters that reflect a change or deviation to one or more parameters used during a real-world execution of the content delivery platform 100. In examples, the market for the simulation execution can be defined by criteria that incudes, for example, a time interval, a geographic area and/or a type of user or user device. Further, a simulation of the content delivery for a particular market can be implemented for a set of conditions that were present during the real-world execution by the content delivery platform 100. For example, a simulation can be selected for a set of conditions that define a time interval (e.g., 4-hour time interval, ending just prior to a current time interval), during which the content delivery platform 100 delivered content items to a particular market (e.g., geographic region).

With further reference to FIG. 2, the simulation system 200 includes a configuration user interface 202, a content delivery platform (“CDP”) interface 210, and a simulation engine 230. The configuration user interface 202 can generate one or more interactive features for enabling a user of the simulation system 200 to (i) specify or define a market for implementing a simulation execution, including a time interval that the simulation execution is to cover; and (ii) specify one or more simulation configurations 205 that seed a change or deviation to the real-world execution by the content delivery platform 100. As described in greater detail, the simulation configurations 205 can include, for example, changes to (i) bidding logic 125 (see FIG. 1) of individual campaigns that were active in the real-world execution, and/or (ii) one or more of the auction processes used in the real-world execution. The changes to the auction process can include (i) changes to the auction process criteria for determining eligibility, scoring and/or ranking of bids 127 by the content delivery platform 100, (ii) changes to the number of slots that are handled by individual auctions, and (iii) changes to how slots are matched to auction processes (e.g., based on a relevancy or match as between the context data associated with the slot and the target for individual campaigns).

Still further, in some examples, the user interface 202 enables a user to specify synthetic data 203 for use with the simulation execution. Synthetic data can include synthesized representations of user devices 12 and/or available slots for the defined market, campaigns, and/or auction processes. Synthesized representations of items can be data-generated to supplement or augment the historical data 148 recorded by the content delivery platform 100. Slots can also be synthesized by changing the number of slots per user session.

In examples, the CDP 210 represents processes that retrieve or otherwise access the historical data 148 of the content delivery platform 100, where the retrieved historical data 148 represents the real-world execution of the content delivery platform 100 for the defined market. The selected segment of the historical data set can be defined in part by criteria, such as a time interval during which auction processes for content delivery actually took place (e.g., X number of hours preceding a current time, etc.). The historical data 148 can include historical slot data that identifies a plurality of available slots that existed in the particular market, where each available slot is associated with a user session and generated as a result of a content placement event on a corresponding user device 12. A user session can be associated with one or multiple slots. The historical data 148 can also include bidding data that represents bidding logic 125 (FIG. 1) used by each campaign that was active for the particular market. The historical bidding data can indicate at least one of a bidding strategy, a bidding pace methodology, and/or a bidding price constraint for a campaign that was active in the particular market of interest. Additionally, the historical data 148 can include historical auction data, which includes can include a list of auctions that were completed by the content delivery platform 100 and which meet the selection parameters for the recorded data set. In examples, the historical auction data identifies, (i) each auction process that was completed by the content delivery platform for the defined market, (ii) the available slot(s) that were the subject of each auction, (iii) contextual information associated with each available slot, and (iv) the candidate campaigns for each auction. In some variations, the historical auction data can also include the submitted bids and the winning bids.

The simulation engine 230 includes processes that simulate execution of the content delivery platform 100 for the defined market, with deviations defined by the simulation configurations 205 and/or synthetic data 203. In examples, the simulation engine 230 includes processes represented by campaign execution component 240, auction simulator 250 and user response simulator 260.

The campaign execution component 240 can define a plurality of campaigns for the simulated domain. The campaigns of the simulation domain can include (i) campaigns that correspond to campaigns that were active for the defined market in the real-world domain, without deviation; (ii) simulated campaigns that correspond to real-world campaigns that were active for the defined market in the real-world domain, with deviation (e.g., as specified by the simulation configurations 205); and/or (iii) synthesized campaigns. Each campaign of the simulated domain can be associated with bidding logic 225, where the bidding logic 225 specifies bidding strategy, pacing methodology, and/or pricing constraints (e.g., maximum/minimum price, initial price, etc.). Accordingly, the campaign execution component 240 can use bidding logic 225 that reflects either of (i) bidding logic 125 of the real-word domain without modification, (ii) bidding logic 125 of the real-world domain with modification (e.g., by simulation configuration 205), and (iii) synthesized bidding logic 225.

In examples, the simulation engine 230 implements substantially the same processes as the content delivery platform 100. The auction simulator 250 includes processes to replicate the auction processes (as represented by the auction module 130) for the selected market. In examples, the auction simulator 250 replicates auctioning processes that include (i) eligibility filtering and campaign matching, (ii) scoring and ranking, based on factors such as relevancy and quality of the respective content items used by the campaign, and (iii) pricing, reflecting, for example, bids received, the ranking of the bids, the maximum bid and winning bid if different than the maximum bid. Accordingly, the auction simulator 250 initiates auction processes for a user session and/or the slots associated with the user session. The sessions can mirror those of the defined market in the real-word domain, while the number of slots associated with each session can vary as an adjustable parameter subject for the simulation domain. Thus, the number of slots used for the simulation domain can include synthesized slots, if, for example, the number of slots for individual sessions is increased for the simulation domain. The available slots of the simulation can be associated with contextual information (e.g., location of user device 12), as well as time stamps when the slot became available. The auction simulator 250 can initiate auctions for each available slot, in a sequence that is based on the time stamps associated with each available slot. The simulation engine 230 can include processes that identify candidate campaigns for each auction process that is to be performed in the simulation domain. For each auction process of the simulation, the campaign execution component 240 executes the bidding logic 225 associated with each candidate campaign to generate bids for each active campaign of the simulation engine 230.

The campaign execution component 240 can include a bidding agent 242 that generates bids based on a selected bidding logic or strategy of the corresponding campaign. The campaign execution component 240 can also include a pacer 244 that implements a pacing methodology, in conjunction with a campaign budget. In examples, the pacer 244 can represent processes of the content delivery platform 100 which implement pacing methodology and price constraints for a campaign. In the simulation domain, the pacer 244 determines whether a bid is to be submitted for a particular auction, as well as the maximum bid amount. Factors which may be considered by the pacer 244 include a number of winning bids for the campaign prior to a current instance, an overall budget for the campaign, a remaining budget for the campaign, a duration of time remaining for the campaign and/or other parameters. The bidding agent 242 and pacer 244 employ a reinforcement learning framework to generate bids 241 based on learned policies and the state of the corresponding campaign. The framework can be based in part on outcomes of prior auction processes. Further, the campaign monitor 246 records campaign state transitions based on bidding outcomes. An outcome of each auction process in which a campaign makes one or more bid submissions is recorded. The recorded outcomes can include the winner of the auction process, as well as the user interactions (e.g., clicks, conversions or other interactions) which take place with respect to the content item selected by the auction process. When a campaign wins an auction process in the simulated domain, the campaign monitor 246 performs the “monitoring” to determine the impact of the auction process outcome on the remaining budget of the campaign. While in the real-word domain, the monitoring can include measuring or recording a user activity, in the simulation domain, the monitoring is determined using projective models and forecasts for the simulation domain.

The user response simulator 260 includes processes that project user interaction with content items selected by the auction simulator 250 (e.g., winning ads). The user response simulator 260 can utilize, for example, probabilistic models to predict a probability of whether an individual device/user will interact with a content item selected through an auction process. Further, the user response simulator 260 can also include processes to determine a probability of a particular type of user interaction, such as viewing/scrolling interaction, user selection (e.g., clicking), and/or the use conducting a transaction in response to viewing/interacting with the content item. As an addition or variation, the user response simulator 260 can implement models and/or other logic to determine a probability of the number of interactions by individual devices, including the number of impressions or views, the number of clicks the content item receives, and/or the number of transactions conducted through interaction with the respective content items. The models used by the user response simulator 260 can be trained and/or calibrated based on data obtained from the real-word domain. The projected responses of the user response simulator 260 can be used by the campaign monitor 246 to adjust the bidding logic and/or activity of corresponding campaigns in the simulation domain.

Additionally, in examples, the projected responses determined by the user response simulator 260 can be to calculate performance metrics for the campaigns in the simulation domain. The performance metrics can identify, for example, the performance and efficacy of individual campaigns in the simulation mode (e.g., through calculation of ROI for the simulated campaign). The predicted probabilities can also be calibrated using empirical data to ensure that the simulated metrics closely match real-world outcomes.

In examples, the simulation system 200 includes an output component 270 to record a simulated data set 272 generated by a simulation execution for a defined market. The simulated data 272 can mirror the historical data 248 of the content delivery platform 100 for the defined market, but the simulated data set 272 reflects outcomes that deviate from those of the real-world domain, stemming from deviations introduced for the simulation. In examples, the deviations of the simulation data set 272 can reflect changes that are directly attributable to the modifications specified by the simulation configurations 205, as well as the effects of the inclusion of synthetic data 203. Additionally, the simulation data set 272 reflects deviations that occur indirectly, as a result of changes that occur to other outcomes. In this regard, the simulation data set 272 captures the full effects of changes to different parameters of a content delivery platform, recognizing the interdependencies that are inherently present in content delivery flows where content items are selected for delivery to users through bidding and auctioning.

In some examples, the output component 270 includes an analysis component 274 which generates results indicating the performance or efficacy of campaigns in the simulation campaigns. Further, the analysis component 274 can compare the efficacy/performance of individual campaigns as between the real-world and simulated executions of the defined market, as well as providing output that indicates other comparative metrics. The comparative metrics can be made based on campaign or platform level metrics, such as number of interactions, number of transactions, revenue generation, etc. For example, an objective of the content delivery platform 100 can include maintaining a high threshold of relevancy as between the content items displayed to users and the user's interest. This relevancy can be measured by the level of interaction by users. Through simulation, the analysis component 274 can compare the total number of interactions resulting from a real-world execution of the content delivery platform 100, versus those projected to occur in a simulated execution in which, for example, the threshold for relevancy is changed in the auction processes. Through such analysis, the outputs and determinations of the simulation system 200 can be used to optimize the configuration of the content delivery platform 100 for specific objectives (e.g., relevancy of content items to user interest).

In some examples, the output component 270 runs a simulation of the real-world execution, to determine a baseline for comparison with a simulation that contains a deviation. The simulation of the real-world execution can be run using the auction data 148, without any deviations. The simulation of the real-world execution can be used to identify and account for systematic bias which may be present in simulations. Further, the simulation of the real-word execution (without deviation) can also be used to validate and/or calibrate simulations where a deviation is made to the real-world execution.

Still further, in some examples, the output component 270 can include a programmatic control mechanism 276 for tuning aspects of the content delivery platform 100 based on determinations of the simulation system 200. For example, in the case where a determination is made that increasing the relevancy threshold furthers the objectives of the content delivery platform 100, the control mechanism 276 can automatically and/or programmatically implement the change with the content delivery platform 100.

### Methodology

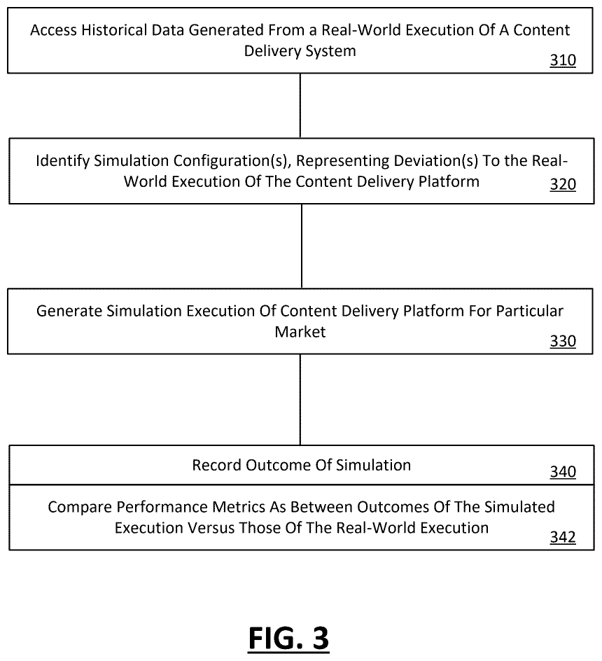

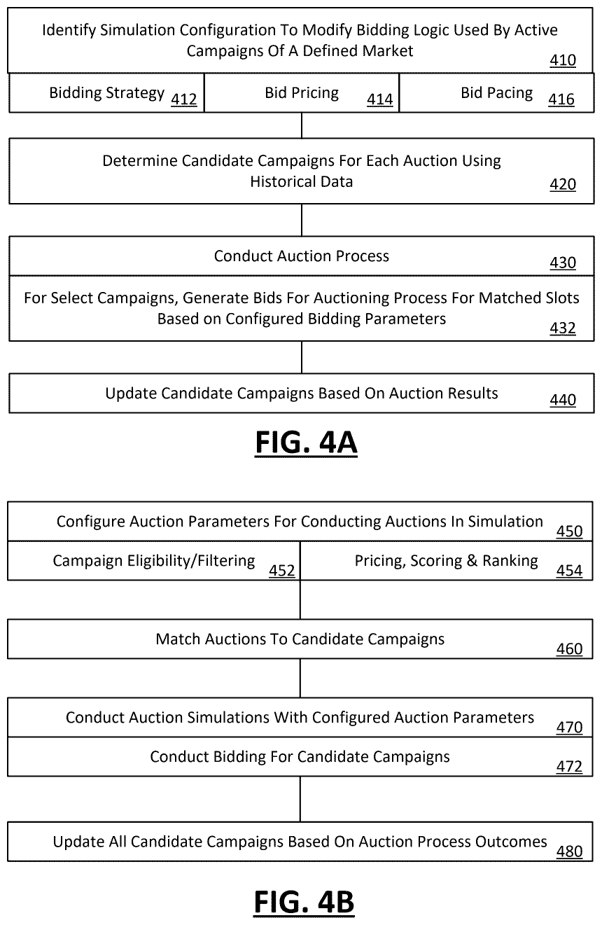

FIG. 3 illustrates an example method for simulating execution of a content delivery platform for a particular market, according to one or more embodiments. FIG. 4A illustrates an example method for performing a simulation execution of a content delivery platform, where the simulation execution is configured by a bidding logic configuration, according to one or more embodiments. FIG. 4B illustrates an example method for performing a simulation execution of a content delivery platform, where the simulation execution is configured by an auction process configuration, according to one or more embodiments. In describing examples of FIG. 3, FIG. 4A and FIG. 4B, reference may be made to elements of FIG. 1 and FIG. 2 for purpose of illustrating components and functionality for performing a step or sub-step being described.

With reference to FIG. 3, in step 310, historical data 148 generated from a real-world execution of the content delivery platform 100 is accessed by the simulation system 200. The accessed historical data 148 can be for a market that is defined by time, geography, user characteristics, user device characteristics and/or other characteristics. For example, a user of the simulation system 200 can interact with a user interface 202 to define a market for the simulation by selecting a time interval (e.g., prior day, specific the prior week, prior four hours, etc.), city, and/or neighborhood (e.g., zip code) to define the market. In response, the simulation system 200 retrieves or otherwise accesses a segment of the historical data generated by the content delivery platform 100, corresponding to the defined market.

As described with examples, the historical data can be generated by the content delivery platform 100 in the course of its execution (i.e., “real-world execution”). The historical data 148 can include slot data, reflecting available slots for the particular market, where each available slot is identified for a user session and/or a content delivery event (e.g., user opening a service application on which the content delivery platform 100 delivers advertisement and promotional content) generated from a user device 12. A user session or content delivery event can be associated with multiple slots, such as multiple regions of a page that is rendered on the user device where advertisement or promotional content can be placed.

In examples, the historical data can also include bidding data, representing bidding logic used by the active campaigns of the defined market. For example, each campaign can be associated with bidding logic that defines a bidding strategy, a bidding pace methodology, and a bidding price constraint.

Further, in examples, the historical data can include auction data that represents the performance of auction processes for the particular market. Each auction process can identify a winning bid submitted by a campaign for an available slot, resulting in an outcome in which a content item associated with the campaign being delivered to and rendered on the user device in place of the available slot. Accordingly, the auction data can identify auction processes that took place to identify a winning bid or outcome. For example, the auction data can identify (i) a set of candidate campaigns that are matched or deemed eligible for an available slot, (ii) the bids that are received for the auctioning of the available slot, (iii) the methodology used to select the winning bid and, and/or (iv) the identification of the winning bid, campaign and/or associated content item.

In step 320, a set of simulation configurations are identified, where each simulation configuration represents a deviation to the real-world execution of the content delivery platform. In examples, the set of simulation configurations can be identified by, for example, user input, made through a user interface 202 of the simulation system 200. In variations, the simulation configurations can be determined by, for example, programmatic mechanisms that automatically determine simulation configurations based on a variety of factors (e.g., performance metrics of the real-world execution of the content delivery platform 100, etc.).

In step 330, a simulation execution of the content delivery platform 100 is generated for the particular market using the set of simulation configurations. The simulation system 200 can be executed, to replay the bidding and auction processes, but with changes represented by the simulation configurations, as well as changes that indirectly result from the simulation configurations. The simulation execution can otherwise utilize bidding and auctioning processes of the content delivery platform 100 to simulate content flows for the particular market. In this way, the simulation execution captures changes to outcomes resulting directly from the change indicated by the simulation configuration, as well as changes to outcomes resulting indirectly but as a result of the change indicated by the simulation configuration. To illustrate, if as a result of a simulation configuration, the simulation execution for the content delivery platform 100 results in a different campaign submitting the winning bid for a particular auction process, that outcome change has rippling effects to subsequent auctions performed for the defined market. For the campaign that wins the particular auction process in the simulation execution but lost the auction process in the real-world execution, the impact of the outcome change can mean that the campaign has less budget for the remainder of the time interval of the defined market of the simulation execution, resulting in that campaign not bidding or losing a subsequent auction process which that particular campaign had won in the real-world execution. Likewise, for a campaign that won the auction process in the real-world execution but loses the auction process in the simulation execution, the impact of the outcome change can mean that the campaign uses additional budget to increase a bid in a subsequent auction process, resulting in the campaign winning the subsequent auction process, also resulting in a different outcome than the real-world execution. The outcome changes of the simulation execution can continue to impact the auction processes that follow in the simulated domain, resulting in the simulation execution having outcome changes in, for example, a series of subsequent auction processes, including in auction processes that were not directly impacted by the simulation configuration.

In step 340, an outcome of the simulation is recorded. The outcome recorded for the simulation can include, for example, which campaigns won auction processes for sessions or slots, the content items that were delivered to the devices 12, and the resulting user interaction with the content items. As described, the user interactions can be projections, based on models that seek to predict if and how users interact with specific content items. The simulation outcomes can reflect, for example, the number and type of interaction (e.g., viewing interaction, selection interaction, transaction interaction, etc.) by users to specific campaigns, as predicted by models used by the simulation system 200.

In some examples, the simulation outcomes can be based on the outcomes of the simulation execution, specifically with respect to the content items that are selected for the available slots. Thus, the outcomes represent the campaigns that submit the winning bids under the simulation execution. In making the comparison, the simulation comparisons can be compared to the real-world outcomes. For example, the distribution of content items from different campaigns, the evenness of the distribution over time, and various other attributes can be analyzed from the comparison of the different outcomes.

In examples, step 342 can include determining performance parameters for the simulation execution, and comparing the performance parameter to the real-world execution. The performance parameters can include system-level parameters, such as the total number of interactions (e.g., views, clicks, conversions) which result from the campaign delivery platform 100 in the real-world execution, as compared to the total number of interactions which are deemed (e.g., through prediction models) to occur during the simulation execution. The comparison of performance parameters can also be made on the campaign level, or through other categorizations of the defined marker.

In examples, the comparison of the simulation and real-world executions are reflected by a comparison of performance parameters for the respective simulated and real-world outcomes. The system 200 can determine one or more performance metrics for one or more of the simulation outcomes. With respect to a set of simulation outcomes, the simulation system 200 can utilize predictive logic or models to determine a probability of a conversion event occurring under a hypothetical scenario where the simulation outcomes were real-world outcomes. For each simulation outcome, the simulation system 200 can also utilize predictive models to determine a probability of a conversion event occurring under a hypothetical scenario where the simulation outcome is a real-world outcome, where the conversion event corresponds to a user of a user device (i) views the selected content item of the outcome, (ii) interacts (e.g., clicks the content item) with the selected content item of the outcome, and/or (iii) conducts a transaction in response to viewing or interacting with the content item of the outcome.

With reference to FIG. 4A, in step 410, a simulation configuration is received for modifying the bidding logic used with one or more active campaigns of a defined market. The bidding logic simulation configuration can be identified from, for example, a user input (e.g., campaign manager interacting with a user interface of the simulation system 200, administrator for content delivery platform 100, etc.). Alternatively, the bidding logic simulation configuration can be received from a programmatic source, or identified programmatically through a triggering event (e.g., a performance metric determined for the content delivery platform 100). In step 412, the bidding logic simulation configuration represents a modification to the bidding strategy of a target set of campaigns. For example, the modification to the bidding logic can specify a starting bid value and the maximum bid value, an increment of the bid value, one or more conditions were the maximum bid value is to be used, and/or a type of interaction or conversion event that the bids are for. The modification to the bidding logic can also modify the pacing methodology. As an addition or alternative, for example, the modification to the bidding logic can vary the determination (or logic for making such determination) when the next bid is made by/for a campaign, based on the outcome of a current auction process.

In step 414, the bidding logic simulation configuration represents a modification to the bid pricing of a target set of campaigns. The bid pricing can represent a constraint value or determinative logic that defines, for example, in context of an auction process, an initial bid value, a maximum bid value, a minimum bid value, and/or increment value between bids.

In step 416, the bidding logic simulation configuration represents a modification to a bid pacing methodology of a target set of campaigns. The bid pacing methodology can include one or more parameters that define the spacing, over time, during which bids for a particular campaign or submitted, including the frequency of the bids, and a relevant portion of an overall budget or remaining budget that individual bids are to receive. Thus, the pacing methodology can determine when (or how frequently) a bid is submitted for a campaign, and the value associated with the bid. The target set of campaigns can be selected (e.g., based on user input) from the active campaigns for the defined market. Alternatively, the target campaigns can represent all of the active campaigns for the defined market.

In step 420, a set of candidate campaigns are identified for each available slots identified through the simulation execution. The candidate campaigns can be identified by matching contextual information associated with each available slot (e.g., time, day, location, application state on user device, etc.) with target information (e.g., keywords) associated with each campaign.

In step 430, the auction process for the available slot is performed. In step 432, during the auction process, the simulation execution includes generating simulated bids from the candidate set of campaigns. While the candidate set of campaigns reflects the real-world campaigns in the defined market, the simulation execution varies the bidding logic, in accordance with the simulation configuration, such that the auction process may yield a different outcome than that which occurred in the real-world execution of the content delivery platform.

In step 440, all candidate campaigns of the auction process are updated based on an outcome of the auction process. For example, the candidate campaign that submitted the winning bid can have its budget reduced accordingly. The reduction in the campaign budget can in turn cause the pacing methodology of that campaign to determine an alternate time for making a next bid submission to an auction process. Still further, the reduction in campaign budget can cause the bidding logic two change, for example, the bid values use with the bid pricing constraints (e.g., maximum or minimum bid values). Further, each candidate campaign that submitted a bid during the auction process can be updated with metrics that reflect the success and/or failure of the campaign, and the bidding logic employed by each campaign can be tuned based on the updated set of metrics.

With reference to FIG. 4A, in step 450, a simulation configuration is identified for conducting one or multiple auction processes during the simulation execution. In particular, the simulation configuration can alter one or more auction parameters used by the one or more auction processes. In step 452, an example provides that the simulation configuration alters one or more parameters that correspond to eligibility or filtering criteria for individual auction processes. For example, an eligibility criterion may correspond to a threshold level of relevancy with respect to the context associated with an open slot, and in the simulation execution, the threshold level of relevancy for all of the auction processes may be raised by a certain value (e.g., 10%). In step 454, an example provides that the simulation configuration is for one or more parameters that are used to select an outcome of the auction (e.g., the winning bid). For example, the simulation configuration can alter a weight that the auction process assigns to one of price (e.g., how much the price associated with a bid is to contribute to the outcome), scoring and ranking (e.g., based on relevancy or quality).

In step 460, during the simulation execution, the auction processes are matched to campaigns, using eligibility and/or filtering criteria (which may be altered by the simulation configuration). The matching of campaigns to auction processes can be based on, for example, the context associated with the available slot of the auction and/or the target of campaigns.

In step 470, the auction processes are conducted during the simulation execution to determine their respective outcomes. In step 472, some examples provide that the auction processes are conducted subject to parametric changes in the manner the auctions are conducted (e.g., changes to the weighting of price, quality and relevancy).

In step 480, the active campaigns for the defined market is updated based on the auction process outcomes. As described with other examples, a change in the outcome for an available slot in the simulation execution can directly impact subsequent events relating to the campaign that generated the winning bid in the simulation execution, as well as to the campaign that generated the winning bid in the real-world execution but not the simulation execution. Further, these changes can ripple through the simulation execution such that the outcomes of other auction processes change as an indirect result of those auction processes which were the subject of the simulation configuration.

### Hardware Description

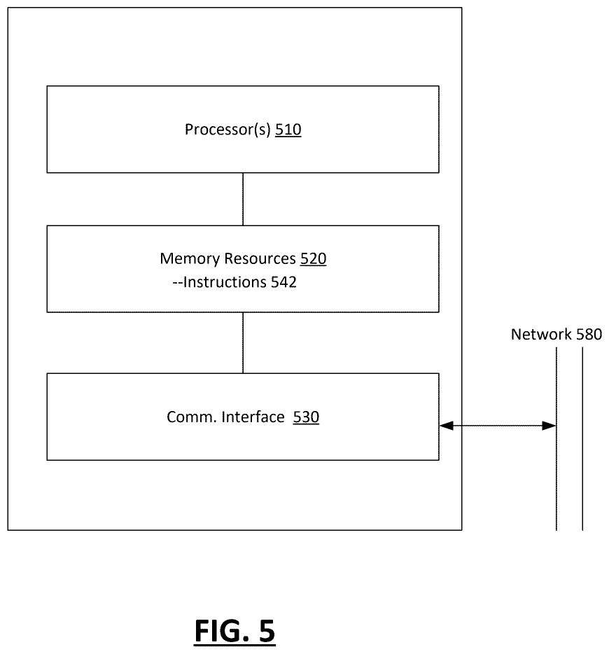

FIG. 5 illustrates a block diagram that illustrates a computer system on which examples described herein may be implemented. For example, in the context of FIG. 1 and FIG. 2, the content delivery platform 100 and the simulation system 200 can be implemented using a computer system or combination of computer systems, such as described by FIG. 5.

In one implementation, the computer system 500 includes one or more processors 510, memory resources 520, and a communication interface 530. The computer system 500 includes at least one processor 510 for processing information. The memory resources 520 may include a random access memory (RAM) or other dynamic storage device, for storing information and instructions to be executed by the processor(s) 510. The memory resources 520 also may be used for storing temporary variables or other intermediate information during execution of instructions to be executed by the processor(s) 510. The computer system 500 may also include other forms of memory resources, such as static storage devices for storing static information and instructions for the processor 510. The memory resources 520 can store information and instructions, including instructions 542 for implementing processes of the content delivery platform 100 and/or simulation system 200. Additionally, the processor(S) 510 can execute the instructions 542 to implement a method such as described with respect to examples of FIG. 3, FIG. 4A and FIG. 4B.

The communication interface 530 can enable the computer system 500 to communicate with one or more networks 580 (e.g., cellular network) through use of the network link (wireless or wireline). Using the network link, the computer system 500 can communicate with one or more other computing devices and/or one or more other servers or data centers. In some variations, the computer system 500 can receive device data and/or service-specific information from user devices 12, as well as other computer systems, such as those operated by third parties.

Examples described herein are related to the use of the computer system 500 for implementing the techniques described herein. According to one embodiment, those techniques are performed by the computer system 500 in response to the processor 510 executing one or more sequences of one or more instructions contained in the memory resource 520. Such instructions may be read into the memory resources 520 from another machine-readable medium, such as the storage device. Execution of the sequences of instructions contained in the main memory 520 causes the processor 510 to perform the process steps described herein. In alternative implementations, hard-wired circuitry may be used in place of or in combination with software instructions to implement examples described herein. Thus, the examples described are not limited to any specific combination of hardware circuitry and software.

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

What is claimed is:

1. A computer system comprising:
one or more processors;
a memory to store instructions;
wherein the one or more processors execute the instructions to perform operations comprising:
accessing historical data generated from a real-world execution of a content delivery platform for a particular market that is defined at least in part by a prior time interval;
determining a set of simulation configurations, each simulation configuration representing a deviation to the real-world execution of the content delivery platform;
generating a simulation execution of the content delivery platform for the particular market using the set of simulation configurations; and
recording outcomes of the simulation execution.

2. The computer system of claim 1, wherein the particular market is defined at least in part by one or more of a geographic parameter, a user parameter, and/or a user device parameter.

3. The computer system of claim 1, wherein the historical data generated from the real-world execution of the content delivery platform includes historical bidding data, the historical bidding data including data that represents bidding logic used by each campaign that was active for the particular market, the bidding data indicating at least one of a bidding strategy, a bidding pace methodology, and/or a bidding price constraint for a corresponding active campaign of the particular market.

4. The computer system of claim 3, wherein the set of simulation configurations include a modification to a bidding logic used by one or more campaigns that were active in the particular market.

5. The computer system of claim 4, wherein the modification includes a change to at least one of a bidding strategy, a pacing strategy or a price input.

6. The computer system of claim 1, wherein the historical data includes historical auction data, the historical auction data comprising representing data that identifies a plurality of auction processes that took place to identify a content item for each available slot of the plurality of slots, the auction data identifying, for each auction process, (i) one or more candidate campaigns that submitted one or more bids for the auction process, and (ii) an outcome of the auction process.

7. The computer system of claim 6, wherein the modification includes a change to one or more auction processes that took place for the particular market.

8. The computer system of claim 6, wherein the set of simulation configurations include a modification to an auction process used to select which content item to place in one or more of the available slots.

9. The computer system of claim 8, wherein the modification to the auction process includes a modification to how the auction process scores and/or ranks individual bids.

10. The computer system of claim 1, wherein the historical data further comprises historical slot data that identifies a plurality of available slots that existed in the particular market, each available slot of the plurality of available slots being generated as a result of a content placement event on a corresponding user device of the plurality of user device.

11. The computer system of claim 10, wherein the operations further comprise:
generating a set of synthetic available slots; and
generating the simulation execution includes utilizing the synthetic available slots and the historical slot data.

12. The computer system of claim 1, wherein the operations further comprise:
determining, from the recorded outcomes, a performance or efficacy of the simulation execution.

13. The computer system of claim 12, wherein determining the performance or efficacy of the simulation execution includes determining a quantity and/or type of user interaction with placement of one or more content items in the simulation execution.

14. The computer system of claim 12, wherein the operations further comprise:
comparing a performance or efficacy of the real-world execution with the performance or efficacy of the simulation execution.

15. The computer system of claim 14, wherein comparing the metric or attribute of the real-world execution with a corresponding metric or attribute of the simulation execution includes comparing a performance metric for placement of one or more content items in the real-world execution with the performance metric determined for the simulation execution.

16. A computer-implemented method, the method being implemented by one or more processors of a computer system, the method comprising:
accessing historical data generated from a real-world execution of a content delivery platform for a particular market that is defined at least in part by a prior time interval;
determining a set of simulation configurations, each simulation configuration representing a deviation to the real-world execution of the content delivery platform;
generating a simulation execution of the content delivery platform for the particular market using the set of simulation configurations; and
recording outcomes of the simulation execution.

17. The computer-implemented method of claim 16, wherein the particular market is defined at least in part by one or more of a geographic parameter, a user parameter, and/or a user device parameter.

18. The computer-implemented method of claim 16, wherein the historical data generated from the real-world execution of the content delivery platform includes historical bidding data, the historical bidding data including data that represents bidding logic used by each campaign that was active for the particular market, the bidding data indicating at least one of a bidding strategy, a bidding pace methodology, and/or a bidding price constraint for a corresponding active campaign of the particular market.

19. The computer-implemented method of claim 18, wherein the set of simulation configurations include a modification to a bidding logic used by one or more campaigns that were active in the particular market.

20. A non-transitory computer-readable medium that stores instructions, which when executed by one or more processors of a computer system, cause the computer system to perform operations that include:
accessing historical data generated from a real-world execution of a content delivery platform for a particular market that is defined at least in part by a prior time interval;
determining a set of simulation configurations, each simulation configuration representing a deviation to the real-world execution of the content delivery platform;
generating a simulation execution of the content delivery platform for the particular market using the set of simulation configurations; and
recording outcomes of the simulation execution.
